(19) United States
(12) Patent Application Publication
(10) Pub. No.: US 2006/0232493 A1
(43) Pub. Date: Oct. 19, 2006

(54) Circular-polarization dipole helical antenna

(75) Inventors: Yuh-Hui Huang, Taoyuan City (TW); Ching-Shu Fang, Taoyuan City (TW)

Correspondence Address: HDSL, 4331 STEVENS BATTLE LANE, FAIRFAX, VA, 22033, US

(73) Assignee: Cirex Technology Corporation

(21) Appl. No.: 11/106,495

(22) Filed: Apr. 15, 2005

(51) Int. Cl. H01Q 1/36

(52) U.S. Cl. 343/895

(57) ABSTRACT

A circular-polarization dipole helical antenna is used for electronic device and satellite terminal and includes a base, and an antenna conductor arranged on surface of the base. The antenna conductor includes a plurality of metal conductors with high Q value and anti-oxidation property and continuously and helically coated on surface of the base. The base is made of low loss and high dielectric constant material. An unbalance-to-balance circuit module connects two signal-feeding ends to the base with phase difference of 180 degree. The problems of narrow bandwidth, low efficiency, complicated structure and precise manufacture can be solved.

### BACKGROUND OF THE INVENTION

1. Field of the Invention

The present invention relates to a circular-polarization dipole helical antenna, especially to a circular-polarization dipole helical antenna with compact and cylindrical dielectric, dipole helical antenna conductors and unbalance-to-balance circuit module, whereby the circular-polarization dipole helical antenna can be fast fine-tuned to electronic device and satellite equipment.

2. Description of Related Art

Mobile electronic devices and satellite terminals, such as mobile phone, GPS, SDAR and satellite TV generally employs circular-polarization antennas for receiving signal. The circular-polarization antenna is generally implemented by strip antenna, which has relatively small covering angle. The reception quality is degraded. Therefore, it is desirable to develop compact circular-polarization antennas with high yield and better signal reception.

Taiwan patent No. 490882 disclosed an antenna having an axis with a central feeder. A pair of helical antenna is connected to the central feeder. Therefore, an antenna with two resonance frequencies in the operation bandwidth larger than 200 MHz can be provided. The interference from other antenna can be suppressed.

Taiwan patent pre-grant publication No. 200404385 disclosed a helical antenna, which comprises a helical coil on a ground plane as terminal. A set of directional array is connected between the antennal and communication equipment.

However, the above-mentioned antenna has helical design, which has narrower bandwidth and is lack of fine-tuning ability. The process precision is more demanding. Moreover, a quarter-wavelength barrel is needed between a resonator and a transmitter for circuit balance. The structure of this antenna is complicated and the cost of this antenna is high.

### SUMMARY OF THE INVENTION

The present invention provides a circular-polarization dipole helical antenna with compact and cylindrical dielectric, dipole helical antenna conductors and unbalance-to-balance circuit module, whereby the circular-polarization dipole helical antenna can be fast fine-tuned to electronic device and satellite equipment.

Accordingly, the present invention provides a circular-polarization dipole helical antenna used for electronic device and satellite terminal and comprising a base, and an antenna conductor arranged on surface of the base. The antenna conductor comprises a plurality of metal conductors with high Q value and anti-oxidation property and continuously and helically coated on surface of the base. The base is made of low loss and high dielectric constant material. An unbalance-to-balance circuit module connects two signal-feeding ends to the base with phase difference of 180 degree. The problems of narrow bandwidth, low efficiency, complicated structure and precise manufacture can be solved.

### BRIEF DESCRIPTION OF DRAWING

The features of the invention believed to be novel are set forth with particularity in the appended claims. The invention itself however may be best understood by reference to the following detailed description of the invention, which describes certain exemplary embodiments of the invention, taken in conjunction with the accompanying drawings in which:

FIG. 1 shows a sectional view of the circular-polarization dipole helical antenna of the present invention.

FIG. 2 shows the radiation pattern of the circular-polarization dipole helical antenna of the present invention.

FIG. 3 shows a relationship between return loss (dB) and frequency (GHz) for the circular-polarization dipole helical antenna of the present invention.

### DETAILED DESCRIPTION OF THE INVENTION

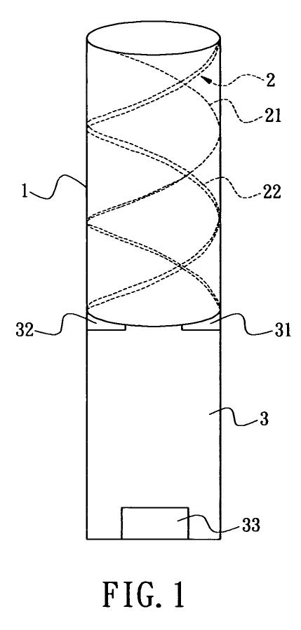

FIG. 1 shows a sectional view of the circular-polarization dipole helical antenna of the present invention. The circular-polarization dipole helical antenna of the present invention comprises a base 1 and an antenna conductor 2 continuously arranged on the surface of the base 1. An unbalance-to-balance circuit module 3 is used connected the circular-polarization dipole helical antenna to a transmission circuit, thus achieving a compact and fast-tuning circular-polarization antenna. The circular-polarization antenna can be advantageously used in applications such as mobile phone, GPS, SDAR and satellite TV.

The base 1 is made of material of low-loss and high dielectric constant. The material can be ceramic such as aluminum oxide and titanium zirconate and engineering plastic such as PS PTFE PEEK FR4 as long as the dielectric constant is larger than or equal to 2. The base 1 has cylindrical shape and has a free end made into the unbalance-to-balance circuit module 3 for connecting to a transmission circuit,

According to a preferred embodiment of the present invention, the antenna conductor 2 comprises conductors 21, 22 of even number and with high Q value and anti-oxidation property. The conductors 21, 22 are coated on the surface of the base 1 with a predetermined phase difference and in helical manner, wherein the base 1 is made of low loss and high dielectric constant material. One end of the conductors 21, 22 is connected to a first signal feeding end 31 and a second signal feeding end 32 of the unbalance-to-balance circuit module 3, respectively, and with 180 degree phase difference to provide unbalance-to-balance conversion function with compact size and high efficiency.

The antenna conductor 2 comprises the conductors 21, 22 made of high Q value and anti-oxidation property and arranged on the surface of the base 1 of low loss and high dielectric constant material in helical manner. Moreover, the antenna conductor 2 can be designed with constant width or variable width to meet specific requirement of user and overcome the problem of narrow bandwidth, low efficiency and unable to fine-tuning.

According to a preferred embodiment of the present invention, the antenna conductor 2 is wrapped with a helical pitch of L and the circumference of the base 1 is C, wherein ¾λ<C< 4/3λ and λ is the wavelength. The current has uniform distribution for arbitrary angle on each circle. The circular-polarization dipole helical antenna of the present invention has broad bandwidth because the pitch is smaller than the wavelength λ.

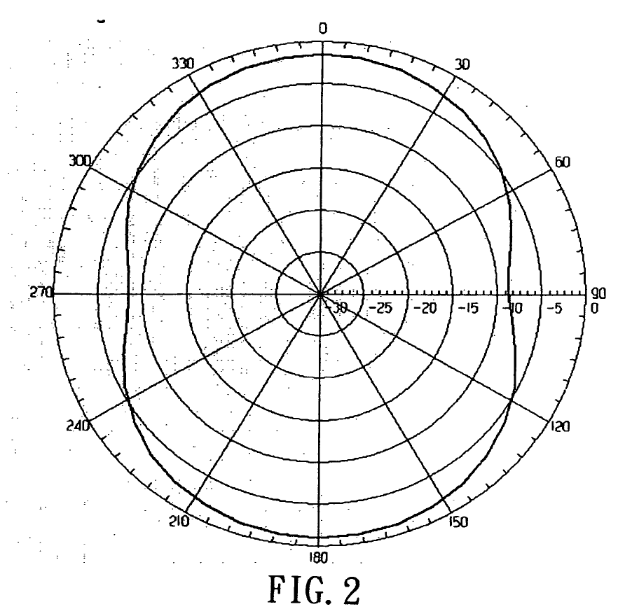

For the circular-polarization dipole helical antenna of the present invention, the radiation field pattern is stable over a broader bandwidth, as shown in FIG. 2. Moreover, the left hand circular polarization and the right hand circular polarization of the dipole helical antenna can be determined by the helical direction of the coil. Therefore, the problem of narrow bandwidth, low efficiency and unable to fine-tuning can be solved.

The unbalance-to-balance circuit module 3 can be directly formed as a free end on the base 1 on which the antenna conductor 2 is not wrapped. The free end comprises the first signal feeding end 31 and the second signal feeding end 32 on an upper end thereof and with 180 degree phase difference and a circuit feeder 33 on a lower end thereof. The circuit feeder 33 is connected to a transmission circuit (not shown) of an electronic apparatus or satellite terminal. Therefore, the unbalance-to-balance circuit module 3 provides signal feeding with 180 degree phase difference to the base 1 and overcome the problem of conventional quarter wavelength barrel structure.

FIG. 2 shows the radiation pattern of the circular-polarization dipole helical antenna of the present invention, which is operated at 2.3G frequency band and in left hand circular polarization (LHCP). The half-power radiation angle is 120 degree and the front-angle gain is −2 dBi. As can be seen from the figure, the circular-polarization dipole helical antenna of the present invention has improved gain and radiation pattern.

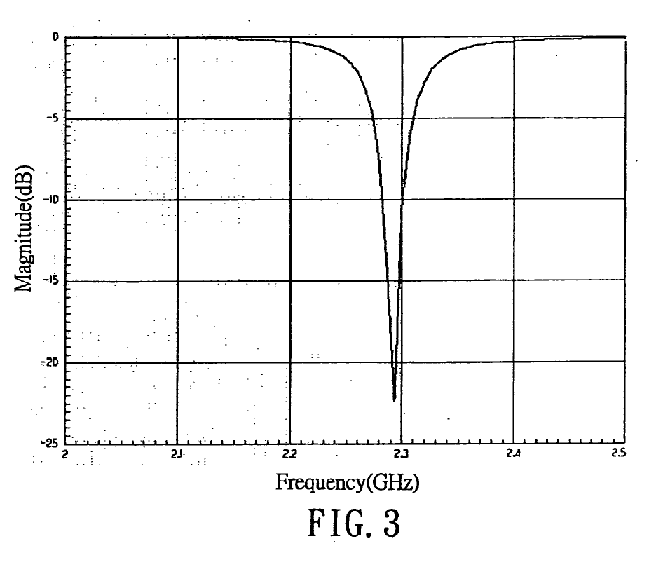

FIG. 3 shows a relationship between return loss (dB) and frequency (GHz) for the circular-polarization dipole helical antenna of the present invention. As can be seen from the figure, the circular-polarization dipole helical antenna of the present invention has peak at a center frequency of 2.29 GHz and bandwidth of 32 MHz.

Although the present invention has been described with reference to the preferred embodiment thereof, it will be understood that the invention is not limited to the details thereof. Various substitutions and modifications have suggested in the foregoing description, and other will occur to those of ordinary skill in the art. Therefore, all such substitutions and modifications are intended to be embraced within the scope of the invention as defined in the appended claims.

1. A circular-polarization dipole helical antenna used for an electronic device and a satellite terminal, comprising
a base;
an antenna conductor arranged on surface of the base; and
an unbalance-to-balance circuit module arranged on the base for connecting the antenna conductor with a transmission circuit of the electronic device and the satellite terminal,
wherein the unbalance-to-balance circuit module is directly formed as a free end of the base on which the antenna conductor is not wrapped,
wherein a first signal feeding end and a second signal feeding end are formed on one end of the unbalance-to-balance circuit module and with 180 degree phase difference and a circuit feeder is formed on the other end of unbalance-to-balance circuit module to connect the transmission circuit, and
wherein the antenna conductor comprises at least one pair of metal conductors continuously and helically coated on surface of the base, the pair of metal conductors having ends connected to the first signal feeding end and the second signal feeding end respectively.

2. (canceled)

3. (canceled)

4. The circular-polarization dipole helical antenna as in claim 1, wherein the base is a cylinder made of low loss and high dielectric constant material.

5. The circular-polarization dipole helical antenna as in claim 1, wherein the base is a cylinder made of ceramic dielectric material or material with dielectric constant larger than or equal to 2.

6. The circular-polarization dipole helical antenna as in claim 1, wherein the antenna conductor comprises a plurality of metal conductors with high Q value and anti-oxidation property and continuously coated on surface of the base.

7. (canceled)

8. The circular-polarization dipole helical antenna as in claim 1, wherein the metal conductors define signal feeding ends with phase difference of 180 degree and provide balance circuit strucure.

9. The circular-polarization dipole helical antenna as in claim 1, wherein the antenna conductor is wrapped with a helical pitch of L and a circumference of the base is C, wherein ¾λ<C< 4/3λ and λ is the wavelength.

10. The circular-polarization dipole helical antenna as in claim 1, wherein the antenna conductor has constant width or variable width.

11. (canceled)

12. (canceled)

13. (canceled)

14. The circular-polarization dipole helical antenna as in claim 1, wherein the base is a cylinder made of ceramic dielectric material or material with dielectric constant between 2 and 5.
